(19) United States
(12) Patent Application Publication
(10) Pub. No.: US 2006/0137501 A1
(43) Pub. Date: Jun. 29, 2006

(54) Apparatus to replace a feed reel for feeding a covering film, to lay and cut a segment of film, and relative method

(76) Inventor: Mario Damo, Oderzo (IT)

Correspondence Address: STEVENS DAVIS MILLER & MOSHER, LLP, 1615 L STREET, NW, SUITE 850, WASHINGTON, DC, 20036, US

(21) Appl. No.: 10/543,611

(22) PCT Filed: Oct. 27, 2003
(86) PCT No.: PCT/IB03/04754

§ 371 Date: Jul. 28, 2005

(30) Foreign Application Priority Data
Feb. 5, 2003 (IT) UD2003A000027

(51) Int. Cl. B26D 5/20

(52) U.S. Cl. 83/277; 83/650

(57) ABSTRACT

Apparatus and method to replace a feed reel for feeding a film and to lay and cut a segment of the film. The apparatus includes a work plane, laying device having its own first gripper, a cutter having its own second gripper, and an unwinding assembly associated with the feed reel. The unwinding assembly includes a guide able to keep the end of the film guided during its insertion into the first gripper of the laying means and the cutting means, a third gripper able to be selectively activated during the change-of-reel step, and a tensioner able to keep the segment of film in tension between the feed reel and the first and second grippers and to allow the recovery of the segment of film during the change-of-reel step without needing to rewind the feed reel.

### FIELD OF THE INVENTION

The present invention concerns an automatic apparatus to replace a feed reel for feeding a covering film made of thermoplastic material, for example to change the color or the width of the film, or to replace an empty reel with a new one. The invention also concerns an apparatus suitable to lay and cut to size a film as it is fed by said feed reel.

The invention also concerns the method to lay and cut a segment of film, and to replace the feed reel from which the film is unwound.

The invention is advantageously applied for the preparation of a covering film, with an aesthetic and/or protective function, for molded articles, for example polyurethane, thermoplastics or other type,

### BACKGROUND OF THE INVENTION

It is known to make articles by means of molding processes, which provide the application into a mold of a decorative film for covering and protection purposes.

In this case, upstream of the molding members which make the articles, apparatuses are installed to lay and cut to size the films made of plastic material.

Such known apparatuses normally comprise one or more reels, at least a gripper which unrolls the film from the reel and lays it on a plane, and a cutting assembly which cuts the film to size.

Examples of such apparatuses are shown in documents EP-A-0.444.418, U.S. Pat. No. 5,323,178 and U.S. Pat. No. 4,514,246.

In such types of apparatus, however, it is difficult to replace the feed reel rapidly, without stopping the process for a long time, both when it is empty and also when it is necessary to change the color and/or width of the film to be applied, without creating joints and off-cuts.

Due to this shortcoming, it is necessary for one or more operators to intervene, thus entailing an increase in the production times, with a consequent increase in costs, and the possibility that problems might occur in finding and assembling the reels, there might be little accidents or other operating problems.

Moreover, known apparatuses have difficulties in guaranteeing that the film, particularly if very thin, as little as a few tenths of a millimetre, can be unwound without creating creases, damages or deformations thereon, which lead to a lower quality of the product covered by such film.

Applicant has devised and embodied the present invention to overcome these shortcomings of the state of the art and to obtain other advantages.

One purpose of the present invention is to achieve an apparatus and a method which allow to automate the steps of laying and cutting to size a film made of plastic material wound on a feed reel.

Another purpose is to achieve an apparatus which will also allow to replace a feed reel in a rapid and completely automatic manner, both when it is empty, and also when it is necessary to change the color and/or width of the film without having recourse to joints and without causing off-cuts and waste.

Another purpose is to guarantee that during all the steps of handling the film it is not possible to have situations wherein the film rubs against other parts, or is crushed inside rollers which guide the film (calender effect), so as to prevent possible damages to the film during the whole cycle to lay and cut the film, and change the reel.

### SUMMARY OF THE INVENTION

The present invention is set forth and characterized in the main claims, while the dependent claims describe other innovative characteristics of the present invention.

The automatic apparatus according to the present invention comprises unwinding means able to unwind the film from a feed reel, laying means able to lay it on a work plane and cutting means able to cut the film to the required measurement. The feed reel is arranged in a first operating position wherein it is in cooperation with said cutting means.

According to a first feature of the invention, the apparatus includes replacement means comprising a store, which is provided with a plurality of new reels mounted in a reel-bearing assembly, which can be the same color and/or width, or different color and/or width with respect to the feed reel in use. The store, and/or the reel-bearing assembly, is able to be moved automatically during the replacement step, so as to take any one whatsoever of the new reels to the operating position cooperating with the cutting means.

With the apparatus according to the present invention it is possible, when it is necessary, to arrange any one of a plurality of new reels in the first operating position cooperating with the cutting means, in a completely automatic manner, thus replacing the empty reels and/or selectively interchanging reels having different colors and/or widths.

According to the invention, a relative unwinding assembly is associated with each of the reels present in the reel-bearing assembly; the unwinding assembly comprises at least plate-type guide means, clamping means with grippers or rollers, and at least a tensioning element with variable positioning, for example a tensioning wheel or suchlike. The plate-type guide means are suitable to be selectively arranged in cooperation with the end of the film emerging from the reel in use, in order to guide it in a controlled manner towards the laying and cutting plane. According to a variant, the plate-type guide means are of the retractable type.

With every reel-change cycle, when the store or reel-bearing assembly is driven to arrange a new reel in the operating position, the guide, clamping and tensioning means are already in the ready position, with the relative end of the film correctly tensioned and arranged to be fed towards the laying and cutting plane.

According to the invention, the feed reel is replaced inside the cycle time, for example the time required for the polyurethane to polymerize, by means of which process the article to be covered is achieved, so that the replacement does not entail any delay in the performance of the process.

In a first embodiment, the store is of the carousel or drum type and has a rotational movement. According to a variant, the store is of the rack type and has a translatory movement. In another embodiment, the store has a coordinated rotational-translatory movement.

The apparatus according to the present invention provides an operating cycle to change the reel and an operating cycle to lay and cut to size the covering film.

The operating cycle to change the reel provides a first step of recovering the film that is being used at that moment, without needing to rewind the film onto the reel thanks to the presence of the tensioning element, and of detaching it from the cutting means; a second step of moving the store/reel-bearing assembly to arrange a new reel in the first operating position cooperating with the cutting means; a third step of inserting the new film on the cutting means; and a fourth step of preparing to start the operating cycle to lay and cut the film.

The operating cycle to lay and cut the film comprises a first step of positioning the cutting means in the programmed position outside the start-of-cycle zone; a second step of gripping the end of the film by the laying means; a third step of positioning and unwinding the film to the required measurement; a fourth step of resting the film on the work plane; a fifth step of cutting the film by the cutting means; and a sixth step of repositioning the laying means and the cutting means in the start-of-cycle position.

With this invention, a reel can be replaced or changed without off-cuts by a new one, when it is empty, in a completely automated manner, and therefore without needing any manual intervention by an operator. This leads to a considerable reduction of the production times and costs, and also an increase in the flexibility of the plant in terms of the use of films of different color and/or format. Moreover, the film is always correctly tensioned and is not subject to any rubbing action by the pressure rollers or other similar elements.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic side view of an apparatus to lay and cut to size a film according to the present invention;

FIG. 2 shows on an enlarged scale the operating assemblies of the apparatus in FIG. 1;

FIGS. 3-9 show the sequence of the laying and cutting cycle of the apparatus in FIG. 1;

FIGS. 10-13 show the sequence of the reel-change cycle of the apparatus in FIG. 1.

### DETAILED DESCRIPTION OF A PREFERENTIAL FORM OF MBODIMENT

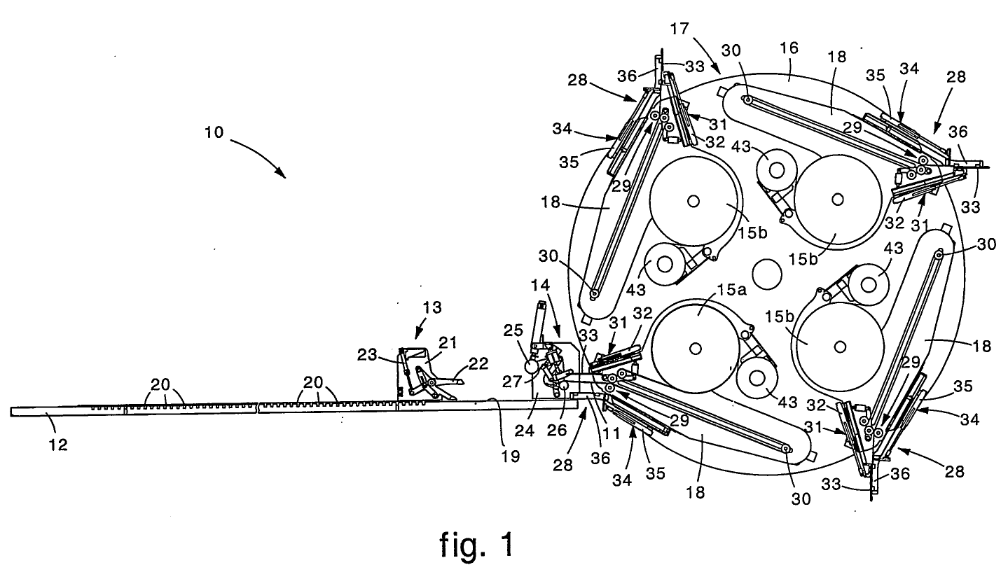

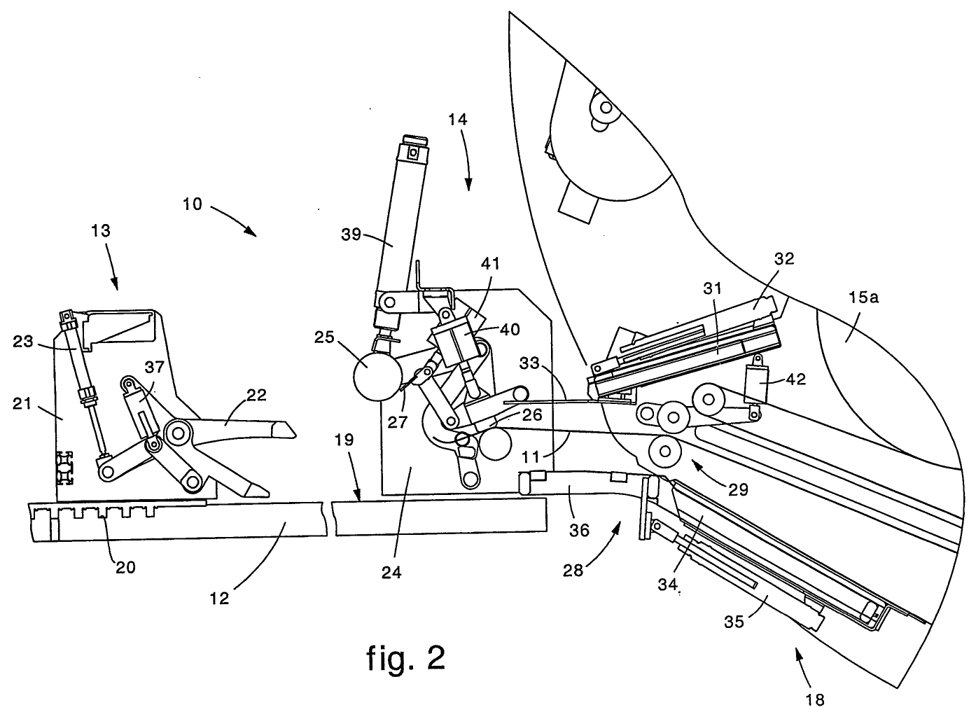

With reference to FIG. 1, an automatic apparatus 10 to lay and cut a film 11, and to replace a feed reel 15, according to the present invention, comprises a work plane 12 on which a laying assembly 13 and a cutting assembly 14 are able to selectively translate. The example shows a rotary drum system with an axis orthogonal to the direction in which the reel 15 is unwound, but said system could include a carousel developing horizontally and/or vertically. The apparatus 10 also comprises, for each of the reels 15, an autonomous unwinding assembly 18 suitable to be mounted on any system whatsoever to move the reels 15.

The film 11 is wound onto a relative reel 15a, arranged in a wheel-type store 16 which, in this case, includes four of said reels 15, arranged at 90°. It comes within the field of the invention that the store can have from a minimum of one to a substantially unlimited maximum of reels 15.

The store 16 is part of a replacement assembly 17 and defines, for the reels 15 arranged thereon, an operating position associated with the cutting assembly 14, and a stand-by position. The feed reel is in the operating position and is indicated by the reference number 15a, while the stand-by reels are indicated by 15b.

With every reel 15 is also associated said unwinding assembly 18 which, during the reel-change step and as will be explained in more detail later, allows to insert one end of the relative reel 15 between the gripping means of the cutting assembly 14.

The work plane 12, on one upper surface 19, has a plurality of suction holes 20, able to be selectively activated by means of automatic valves, connected to means to create a vacuum of a known type and not shown in the drawing. The work plane 12 is able to selectively retain the film 11 according to the steps of the cycle in progress.

The laying assembly 13 comprises a carriage 21 able to slide linearly along the upper surface 19 of the work plane 12, on which are mounted gripping pincer means 22, able to retain one end of the film 11 and associated with a relative opening/closing actuator 37. A second actuator 23 is also mounted on the carriage 21 and is suitable to move the gripping pincer 22 from a distanced position to a position wherein it rests on the upper surface 19 of the work plane 12.

The cutting assembly 14 is located between the laying assembly 13 and the reel 15a in use and comprises a carriage 24 which is also movable linearly on the upper surface 19 of the work plane 12. On the carriage 24 are mounted: a pressure roller 25, associated with a relative actuator 39 able to move it between a raised position and a lowered position; comb-type gripping means 26, with relative actuator 40, to hold the film 11 after insertion; and a pair of knives 27, with relative actuator 41, arranged aligned with each other and transverse to the carriage 24. Instead of the pair of knives 27 there can be a single knife with relative drive actuator.

The unwinding assembly 18 comprises a retractable guide assembly 28, a clamping device 29 with rollers (which could also be with pincers), commanded by a relative opening/closing actuator, and a tensioning wheel 30 which determines the tensioning of the film 11 between the reel 15a in use and the gripping means 22 and 26 of the laying assembly 13 and the cutting assembly 14.

The retractable guide assembly 28 comprises a first upper block 31 provided with a linear actuator 32, to whose rod an upper retaining plate 33 with a comb-type end is connected, and a second lower block 34 provided with a linear actuator 35, to whose rod an abutment plate 36 is connected. The upper retaining plate 33 and the abutment plate 36 define the linearly retractable guide elements which allow a guided and controlled unwinding movement of the film 11 from the feed reel 15 to the laying assembly 13 and the cutting assembly 14.

The upper retaining plate 33 is connected to means to create a vacuum, of a known type and not shown in the drawings, which allow to selectively retain the film 11 when it is inserted between the comb-type gripping means 26 of the cutting assembly 14. The coordinated drive of the actuators 32 and 35 leads to the closure of the retaining plate 33 and of the abutment plate 36 towards the film 11, guiding it forwards towards the cutting assembly 14.

It comes within the filed of the invention that also, or only, the lower abutment plate 36 can have vacuum means that can be selectively activated.

Command and control means are also present, but are not shown in detail here.

The apparatus 10 to lay and cut a film, and replace a reel, as described heretofore functions as follows.

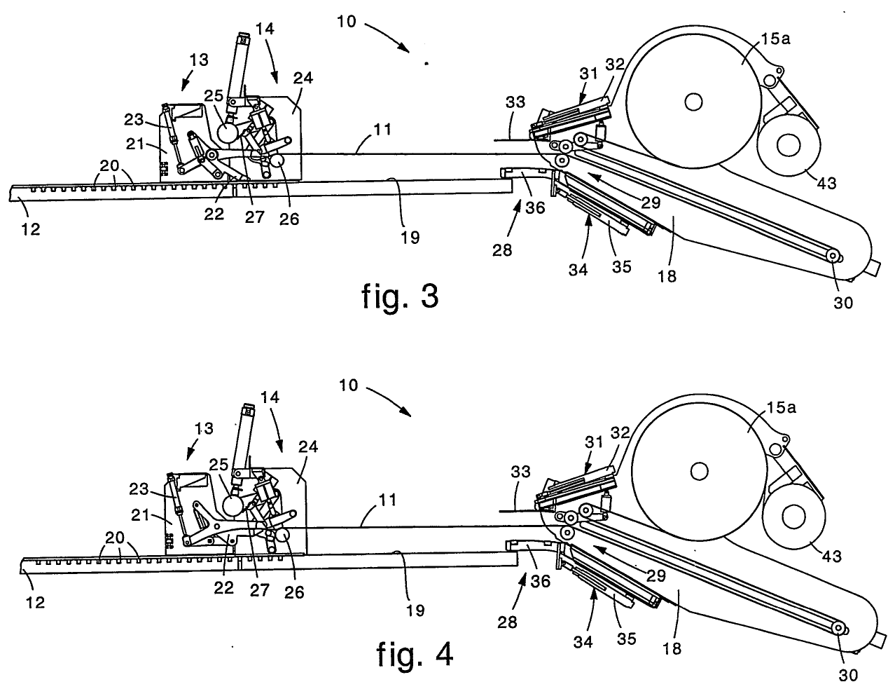

The first operating cycle to lay and cut the film 11 provides a first inactive position (FIG. 3) wherein one end of the film 11 is retained by the comb-type gripping means 26 of the cutting assembly 14 and emerges from the cutting assembly 14 towards the laying assembly 13. The film 11 is kept always under tension by means of the tensioning wheel 30, which can oscillate with respect to a pivoting point; the tensioning wheel 30 also controls the unwinding cycle of the reel 15.

In a first step, the laying assembly 13 and the cutting assembly 14 move independently, from the inactive position and towards the reel 15a, to a zero position which determines the zeroing of the device to measure the length of the segment of film 11 to be unwound.

In a second step (FIG. 4), in the laying assembly 13 the gripping pincer 22 is closed in order to retain the end of the film 11, and subsequently the comb-type gripping means 26 of the cutting assembly 14 are opened.

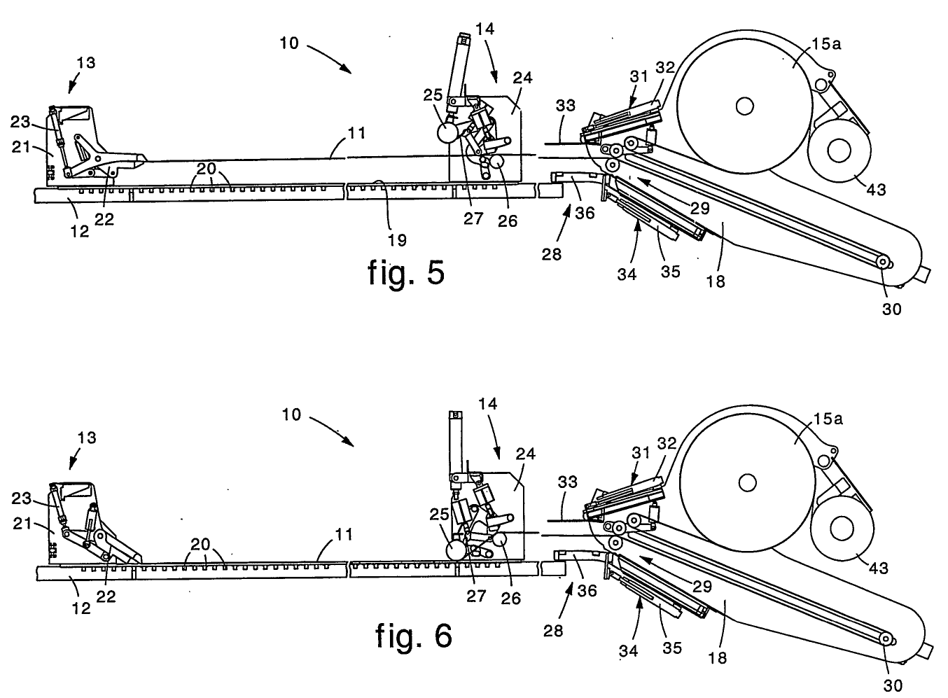

The third step (FIG. 5) provides to move the carriage 21 of the laying assembly 13 towards the end of the work plane far from the reel 15a in use; the film 11 is thus unwound until the portion between the cutting assembly 14 and the laying assembly 13 reaches the desired length.

Advantageously, the carriages 21 and 24 are commanded by a mechanism with a controlled axis, which guarantees the precision of movement to the exact measurement required.

In the fourth step (FIG. 6), the linear actuator 23 of the laying assembly 13, the pressure roller 25 of the cutting assembly 14 and, subsequently, the means to create a vacuum associated with the suction holes 20 present on the upper surface 19 of the work plane 12 are all driven simultaneously. The portion of film 11 which has to be cut is tensed, by means of the tension generated by the tensioning wheel 30, on the work plane 12 and retained thereon.

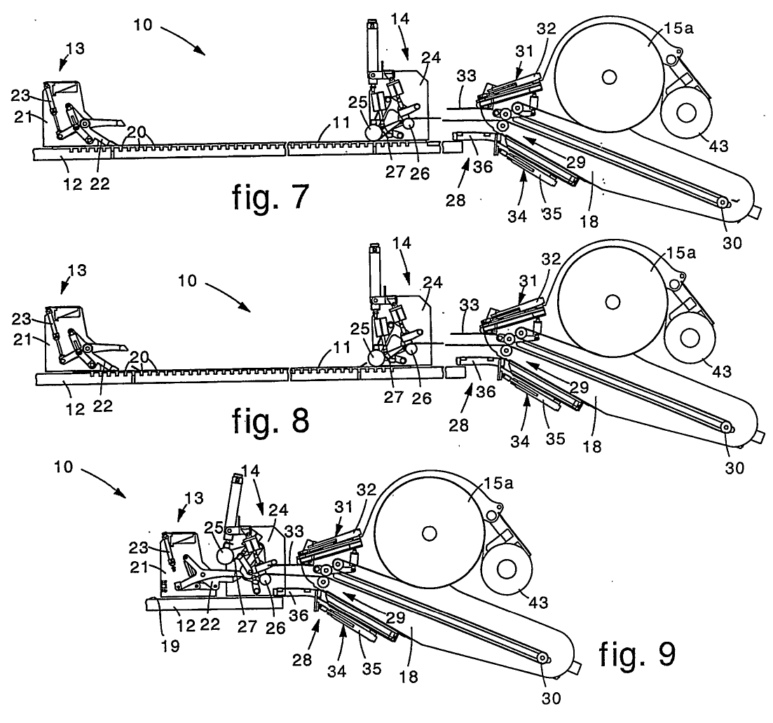

The fifth step (FIG. 7) provides to close the comb-type gripping means 26 in order to retain the film 11, to activate the cutting knives 27, which have been taken to the cutting zone by the movement of the actuator 41, in order to cut to size the portion of film 11, and to open the gripping pincer 22, using the actuators 23 and 37 in coordinated manner, with the possibility in all cases of keeping the upper element of the gripping pincer 22 resting on the film so as to facilitate the vacuum hold on the film 11. When cutting is terminated (FIG. 8), both the laying assembly 13 and the cutting assembly 14 are distanced longitudinally from the cut portion of film 11.

Then, in a sixth step (FIG. 9), the gripping pincer 22 is arranged open and raised from the work plane 12 and the laying assembly 13 and the cutting assembly 14 are positioned in proximity with the reel 15a, so as to allow the cut portion of film 11 to be discharged and to start a new cycle to lay and cut to size the film 11. The excess part of film that has to be rewound during the sixth step is accumulated on the tensioning wheel 30 without needing to rewind the reel 15a.

In the event that the reel 15a is finished, or that there is a need to change the color and/or width of the film 11, the reel-change operating cycle is started.

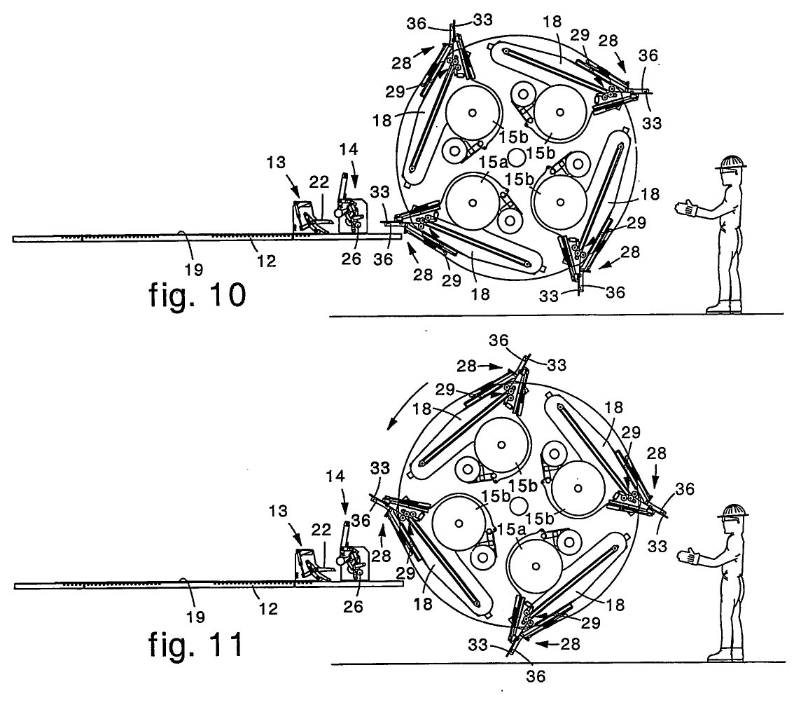

The reel-change cycle provides a first step (FIG. 10) wherein the laying assembly 13 is arranged in a position of non-interference and the cutting assembly 14 moves away from the reel 15a with the film 11 gripped so as to free space for the upper retaining plate 33. Then, the linear actuator 32 of the retractable guide assembly 28 takes the upper retaining plate 33 to a position wherein it grips the film 11, possibly by activating the relative vacuum means; at this point the cutting assembly 14 retreats to the discharge position with the film tensioned by the tensioning wheel 30. Then the tensioning wheel 30 is clamped in position, the clamping device 29 is closed, the comb-type gripping means 26 located in the cutting assembly 14 are opened and the actuator 35 is driven so as to command the advance of the lower abutment plate 36. At this point the cutting assembly 14 advances in order to free the comb-type gripping means 26 from interference with the upper retaining plate 33; the lower abutment plate 36 is also driven to take it into cooperation with the upper plate 33, so as to retain between them the end of the film for the possible subsequent cycle.

Then (FIG. 11), the wheel-type store 16 is rotated until a new reel 15b is arranged in a position of cooperation with the cutting assembly 14.

In this position the end of the film 11 is already in the position necessary for the subsequent laying and cutting steps. Moreover, the unwinding assembly 18 of the new reel 15b is in a configuration identical to the unwinding assembly 18 of the reel 15a previously present.

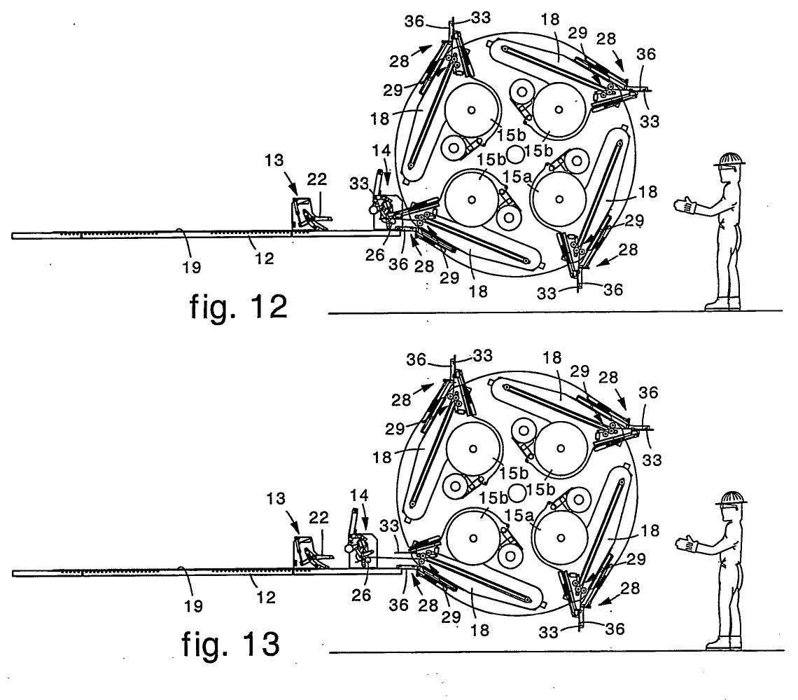

In the third step (FIG. 12), the method provides to drive the means to create a vacuum connected to the upper retaining plate 33.

Then, with the comb-type gripping means 26 open, the cutting assembly 14 retreats for a fixed distance towards the plates 33 and 36; subsequently the actuator 35 is driven and the lower abutment plate 36 is retracted.

Finally, the retreat of the cutting assembly 14 is completed until the film 11 and the comb of the upper retaining plate 33 have been completely inserted, so as to position the end of the film 11 engaged on the comb-type gripping means 26 of the cutting assembly 14. Once the comb-type gripping means 26 have been closed (FIG. 13), the vacuum means are excluded, the clamping device 29 is opened and the tensioning of the tensioning wheel 30 is activated, the cutting assembly 14 is made to advance to a defined distance, the upper retaining plate 33 retreats and the laying assembly 13 and the cutting assembly 14 are returned to the inactive position. At this point a new cycle can be started to lay and cut to size the film 11, as previously described.

As can be seen, the reel change can take place in a completely automatic manner and without forming joints or off-cuts.

In this case, every reel 15 is associated with a roller 43 to wind a detachable covering support.

It is clear that modifications and/or additions of parts can be made to the apparatus 10 as described heretofore, without departing from the field and scope of the present invention.

For example, instead of a store 16 with a wheel as described, the invention can use in the same way and substantially with the same operating steps a rack-type store with horizontal or vertical movement, or any other type of store suitable for the purpose.

1. Apparatus to replace at least a feed reel for feeding a film made of thermoplastic material, and to lay and cut a segment of said film, said apparatus comprising
a work plane,
laying means having their own first gripping means,
cutting means arranged between said laying means and said feed reel and having their own second gripping means, and
an unwinding assembly associated with said feed reel, wherein said unwinding assembly includes guide means able to keep the end of said film guided during its insertion into said first gripping means of the laying means and said second gripping means of the cutting means, third gripping means able to be selectively activated at least during the change-of-reel step, and tensioning means able to keep the segment of film in tension between said feed reel and said gripping means and to allow the recovery of said segment of film at least during the change-of-reel step without needing to rewind the feed reel.

2. Apparatus as in claim 1, wherein said guide means are of the retractable type and comprise a first actuator member driving an upper retaining plate and a second actuator member driving a lower abutment plate, said upper and said lower plates being able to retain one end of said film fed from said feed reel and to be made to advance selectively towards said laying and said cutting means in order to keep said end of the film guided during its insertion into the relative first and second gripping means.

3. Apparatus as in claim 1, wherein at least said upper retaining plate comprises suction means to selectively retain said film due to depression until it is inserted into said gripping means.

4. Apparatus as in claim 1, wherein said laying means comprise first carriage means movable linearly along said work plane, said first carriage means supporting said first gripping means selectively openable and closeable by means of actuator means.

5. Apparatus as in claim 1, wherein said actuator means are able to move said first gripping means from a condition wherein they are distant from said work plane to a condition wherein they are in contact with said work plane in order to clamp said film at least during the cutting step.

6. Apparatus as in claim 1, wherein said cutting means comprise second carriage means movable linearly on said work plane in an intermediate position between said laying means and said feed reel, said second carriage means supporting second said gripping means selectively openable and closeable.

7. Apparatus as in claim 6, wherein said second carriage means support at least a pressure roller movable between a raised position and a lowered position in order to selectively clamp said film on said work plane.

8. Apparatus as in claim 7, wherein said second carriage means support cutting means able to be selectively activated in order to cut said film clamped on said work plane by said pressure roller.

9. Apparatus as in claim 7, wherein said work plane comprises suction holes selectively activable in order to retain said film at least during the laying and cutting steps.

10. Apparatus as in claim 1, further comprising a store provided with a feed reel and at least one replacement reel, each of said reels being associated with a relative unwinding assembly, said store being movable to take a desired one of said replacement reels to an operating position cooperating with said laying means and/or said cutting means, wherein said replacement reels are different in color and/or width from the feed reel in use.

11. Apparatus as in claim 10, wherein said store comprises a rotary element with an axis orthogonal to the axis of unwinding, said reels being mounted on said rotary element, said rotary element being able to take the selected reel to said first operating position.

12. Apparatus as in claim 10, wherein said store comprises a rack or carousel-type element on which said reels are mounted and is able to be translated horizontally or vertically to take one of said reels to said first operating position.

13. Method to automatically replace a feed reel for feeding a film with a replacement reel in an apparatus comprising a work plane, a store for the reels, laying means having first gripping means, cutting means having second gripping means and an unwinding assembly associated with each of said reels and comprising guide means, third gripping means and tensioning means, comprising the following steps:
a step wherein said guide means pick up the end of the film from the feed reel and the tensioning means are driven in order to tension the segment of film between them and the second gripping means of the cutting means;
a step wherein said third gripping means of the unwinding assembly are closed on said segment of film, the second gripping means of the cutting means are opened and the cutting means are distanced from the feed reel in order to free themselves from interference with said film;
a step wherein the tensioning means are driven in order to recover the strip of film protruding from the guide means;
a step wherein the store for the reels is driven in order to arrange said replacement reel in an operating position wherein said replacement reel has its end already in a suitable position for the start of the cycle;
a step wherein said guide means are made to advance towards said cutting means, and the cutting means are brought near to said replacement reel until the relative second gripping means are located to grip on the film, after which said second gripping means are closed on the film;
a step wherein said guide means release said film, said third gripping means of the unwinding assembly are opened and said tensioning means are activated, the cutting means are distanced from said replacement reel for a defined distance, said guide means retreat and said laying means and said cutting means are taken to the position to start a cycle to lay and cut said film.

14. Method to lay and cut a film fed from a reel in an apparatus comprising laying means having first gripping means, cutting means having second gripping means and an unwinding assembly associated with each of said reels and comprising guide means, third gripping means and tensioning means, comprising the steps of:
a step wherein said laying means and said cutting means are displaced towards the reel to a zero position which determines the zeroing of the device that measures the length of the segment of film to be unwound;
a step wherein the first gripping means of the laying means close in order to retain the end of said film;
a step wherein the laying means are distanced from the reel in order to unwind the film until the portion between the cutting means and the laying means reaches the desired length;
a step wherein said film is pressed against said work plane, the gripping means of the cutting means are closed on the film and cutting elements present on said cutting means are driven;
a step wherein, once the film has-been cut, the laying means and the cutting means are distanced from the cut portion of film;
a step wherein the gripping means of the laying means open and the laying means and the cutting means are positioned in proximity with said reel in order to allow the cut portion of film to be discharged.
